(19) United States
(12) Patent Application Publication
(10) Pub. No.: US 2023/0369688 A1
(43) Pub. Date: Nov. 16, 2023

(54) SOLID-STATE BATTERY AND SOLID-STATE BATTERY MANUFACTURING METHOD

(71) Applicant: FDK CORPORATION, Tokyo (JP)

(72) Inventors: Akihiro MITANI, Tokyo (JP); Satoshi HIGUCHI, Tokyo (JP); Toshiaki NAKANO, Tokyo (JP); Masakazu KOBAYASHI, Tokyo (JP); Minako SUZUKI, Tokyo (JP)

(73) Assignee: FDK CORPORATION, Tokyo (JP)

(21) Appl. No.: 18/223,729

(22) Filed: Jul. 19, 2023

Related U.S. Application Data
(63) Continuation of application No. PCT/JP2022/000421, filed on Jan. 7, 2022.

(30) Foreign Application Priority Data
Mar. 29, 2021 (JP) 2021-055338

(51) Int. Cl. H01M 50/11; H01M 50/172; H01M 50/117; H01M 10/04; H01M 10/052; H01M 10/058

(52) U.S. Cl. CPC H01M 50/11; H01M 50/172; H01M 50/117; H01M 10/049; H01M 10/052; H01M 10/058

(57) ABSTRACT

A solid-state battery includes a solid-state battery body and a coating film. The solid-state battery body has an electrolyte layer containing a solid electrolyte, a positive electrode layer formed on a part of a first principal plane of the electrolyte layer, and a negative electrode layer formed on a part of a second principal plane of the electrolyte layer opposite to the first principal plane. The coating film has an insulating property and covers the solid-state battery body so as to expose a first portion of the positive electrode layer and a second portion of the negative electrode layer. The coating film has hardness higher than that of solid electrolytes contained in the solid-state battery body.

### CROSS-REFERENCE TO RELATED APPLICATION

This application is a continuation application of International Application PCT/JP2022/000421 filed on Jan. 7, 2022, which designated the U.S., which is based upon and claims the benefit of priority of the prior Japanese Patent Application No. 2021-055338, filed on Mar. 29, 2021, the entire contents of each are incorporated herein by reference.

### FIELD

The embodiment discussed herein relates to a solid-state battery and a solid-state battery manufacturing method.

### BACKGROUND

Solid-state batteries in which a solid electrolyte is used as an electrolyte in place of an electrolyte solution are known. A technique for covering the surface of a battery element in which a solid electrolyte layer is located between a positive electrode layer and a negative electrode layer opposite each other with a protection layer containing a high polymer is known regarding the solid-state batteries. Furthermore, a technique for covering the surface of a battery element with a protection layer made of an insulating material other than resin is known. In this case, a crack or falling off caused by adsorbing moisture or gas is less likely to occur, bonding strength between the battery element and the protection layer is high, and falling off caused by vibration, shock, or the like is less likely to occur, compared with the protection layer containing a high polymer. In addition, a technique for using glass or a ceramic as such an insulating material is known.
International Publication Pamphlet No. WO2020/054544
International Publication Pamphlet No. WO2020/054549

By the way, a solid-state battery in which a solid-state battery body including an electrolyte layer and a positive electrode layer and a negative electrode layer partially formed on both principal planes of the electrolyte layer is covered with a protection layer formed by the use of a solid electrolyte is known. With a solid-state battery in which a solid electrolyte is used in this way as a protection layer, however, it may be that sufficient strength is not obtained depending on implementation or environment in which it is used. Lack of the strength of a solid-state battery may lead to a crack or a chip in the protection layer or, for example, entrance of moisture or gas into the inside of the solid-state battery caused by the crack or the chip. As a result, the performance of the solid-state battery may deteriorate.

### SUMMARY

According to an aspect, there is provided a solid-state battery including a laminated body having an electrolyte layer containing a solid electrolyte, a positive electrode layer provided on a part of a first principal plane of the electrolyte layer, and a negative electrode layer provided on a part of a second principal plane of the electrolyte layer opposite to the first principal plane and an insulating coating film which covers the laminated body so as to expose a first portion of the positive electrode layer and a second portion of the negative electrode layer and which has a hardness higher than a hardness of the solid electrolyte.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIGS. 1A through 1C are views for describing an example of a solid-state battery;

FIGS. 2A and 2B are views for describing a configuration example of a solid-state battery (part 1);

FIGS. 3A and 3B are views for describing a configuration example of a solid-state battery (part 2);

FIGS. 4A and 4B are views for describing an example of a coating film of a solid-state battery;

FIGS. 5A through 5E are views for describing an example of a positive electrode layer part formation process (part 1);

FIGS. 6A through 6C are views for describing an example of a positive electrode layer part formation process (part 2);

FIGS. 7A through 7E are views for describing an example of a negative electrode layer part formation process (part 1);

FIGS. 8A through 8C are views for describing an example of a negative electrode layer part formation process (part 2);

FIGS. 9A and 9B are views for describing an example of a structural body formation process;

FIGS. 10A through 10D are views for describing another example of a structural body formation process (part 1);

FIGS. 11A through 11D are views for describing another example of a structural body formation process (part 2);

FIGS. 12A and 12B are views for describing an example of a structural body cutting process;

FIGS. 13A and 13B are views for describing an example of a structural body heat treatment process;

FIGS. 14A through 14E are views for describing another example of a solid-state battery manufacturing method (part 1);

FIGS. 15A through 15C are views for describing another example of a solid-state battery manufacturing method (part 2); and

FIGS. 16A through 16C are views for describing another example of a solid-state battery manufacturing method (part 3).

### DESCRIPTION OF EMBODIMENTS

(Solid-State Battery)

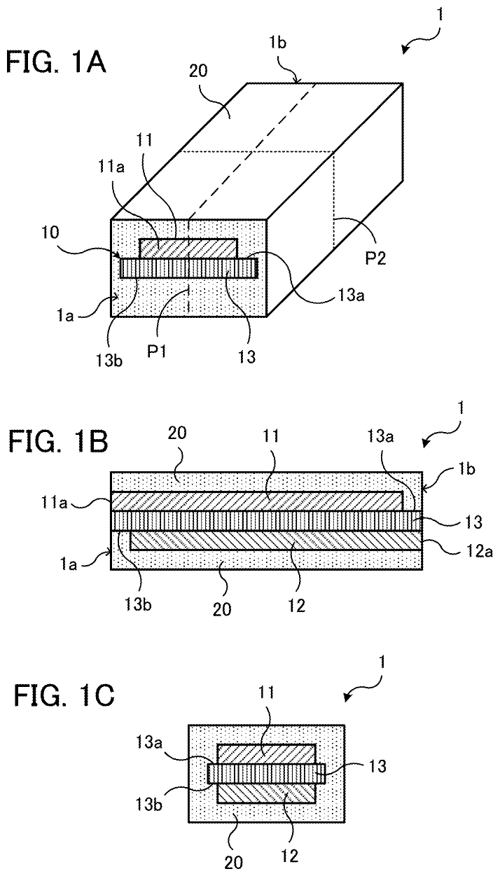

FIGS. 1A through 1C are views for describing an example of a solid-state battery. FIG. 1A is a fragmentary schematic perspective view of an example of a solid-state battery. FIG. 1B is a schematic sectional view taken along the chain line P1 of FIG. 1A. FIG. 1C is a schematic sectional view taken along the dotted line P2 of FIG. 1A.

A solid-state battery 1 illustrated in FIGS. 1A through 1C is an example of a chip type battery. The solid-state battery 1 includes a solid-state battery body 10 and a coating film 20.

The solid-state battery body 10 includes an electrolyte layer 13, a positive electrode layer 11 laminated on one principal plane 13a (also referred to as a first principal plane) of the electrolyte layer 13, and a negative electrode layer 12 laminated on the other principal plane 13b (also referred to as a second principal plane) of the electrolyte layer 13 opposite to the principal plane 13a. The solid-state battery body 10 is an example of a laminated body of the electrolyte layer 13, the positive electrode layer 11, and the negative electrode layer 12.

The electrolyte layer 13 contains a solid electrolyte. An oxide solid electrolyte is used as the solid electrolyte contained in the electrolyte layer 13. For example, LAGP which is a kind of Na super ionic conductor (NASICON) type oxide solid electrolyte is used for forming the electrolyte layer 13. LAGP is an oxide solid electrolyte expressed by the general formula Li₁₊ₓAlₓGe₂₋ₓ(PO₄)₃ (0<x≤1) and is referred to as aluminum-substituted germanium lithium phosphate or the like. For example, Li_{1.5}Al_{0.5}Ge_{1.5}(PO₄)₃ obtained in the case of composition ratio x=0.5 in the above general formula is used as LAGP used for forming the electrolyte layer 13.

The positive electrode layer 11 laminated on the one principal plane 13a of the electrolyte layer 13 contains a positive electrode active material. For example, lithium cobalt pyrophosphate (Li₂CoP₂O₇; hereinafter this will be referred to as “LCPO”) is used as the positive electrode active material contained in the positive electrode layer 11. The positive electrode layer 11 may contain not only the positive electrode active material but also a solid electrolyte and a conductive assistant. For example, the oxide solid electrolyte used for forming the electrolyte layer 13 and a material used as the solid electrolyte contained in the positive electrode layer 11 are of the same kind. That is to say, in this example LAGP is used as an oxide solid electrolyte contained in the positive electrode layer 11. A carbon material, such as carbon fiber, carbon black, graphite, graphene, or carbon nanotube, is used as the conductive assistant contained in the positive electrode layer 11.

The negative electrode layer 12 laminated on the other principal plane 13b of the electrolyte layer 13 contains a negative electrode active material. For example, titanium oxide (TiO₂) is used as the negative electrode active material contained in the negative electrode layer 12. The negative electrode layer 12 may contain not only the negative electrode active material but also a solid electrolyte and a conductive assistant. For example, the oxide solid electrolyte used for forming the electrolyte layer 13 and a material used as the solid electrolyte contained in the negative electrode layer 12 are of the same kind. That is to say, in this example LAGP is used as an oxide solid electrolyte contained in the negative electrode layer 12. A carbon material, such as carbon fiber, carbon black, graphite, graphene, or carbon nanotube, is used as the conductive assistant contained in the negative electrode layer 12.

In the solid-state battery body 10 which is a laminated body of the electrolyte layer 13, the positive electrode layer 11, and the negative electrode layer 12, the positive electrode layer 11 is formed on part of the principal plane 13a of the electrolyte layer 13, the negative electrode layer 12 is formed on part of the principal plane 13b of the electrolyte layer 13, and the positive electrode layer 11 and the negative electrode layer 12 overlap each other with the electrolyte layer 13 therebetween.

In the solid-state battery body 10 lithium ions are conducted from the positive electrode layer 11 via the electrolyte layer 13 to the negative electrode layer 12 and are taken in, at charging time. At discharging time, lithium ions are conducted from the negative electrode layer 12 via the electrolyte layer 13 to the positive electrode layer 11 and are taken in. In the solid-state battery body 10 charging and discharging operations are realized by the above lithium ion conduction.

The coating film 20 covers the solid-state battery body 10 so as to expose part of the positive electrode layer 11 of the solid-state battery body 10 and part of the negative electrode layer 12 of the solid-state battery body 10. In this example the coating film 20 covers the solid-state battery body 10 so as to expose a portion 11a (also referred to as a first portion) of a side of the positive electrode layer 11 and a portion 12a (also referred to as a second portion) of a side of the negative electrode layer 12. The portion 11a of the positive electrode layer 11 and the portion 12a of the negative electrode layer 12 are opposite each other in a direction perpendicular to the direction in which the electrolyte layer 13, the positive electrode layer 11, and the negative electrode layer 12 are laminated. The portion 11a of the positive electrode layer 11 and the portion 12a of the negative electrode layer 12 exposed from the coating film 20 are used for electrical connection with the outside of the solid-state battery body 10. In this case, a side of the solid-state battery 1 on which the portion 11a of the positive electrode layer 11 is exposed from the coating film 20 will be referred to as a positive electrode lead surface 1a and a side of the solid-state battery 1 on which the portion 12a of the negative electrode layer 12 is exposed from the coating film 20 will be referred to as a negative electrode lead surface 1b.

The positive electrode layer 11 is formed on the part of the principal plane 13a of the electrolyte layer 13. The coating film 20 covers the solid-state battery body 10 so as to be in contact with the other part of the principal plane 13a of the electrolyte layer 13 and the surface of the positive electrode layer 11 except the portion 11a exposed on the positive electrode lead surface 1a. The negative electrode layer 12 is formed on the part of the principal plane 13b of the electrolyte layer 13. The coating film 20 covers the solid-state battery body 10 so as to be in contact with the other part of the principal plane 13b of the electrolyte layer 13 and the surface of the negative electrode layer 12 except the portion 12a exposed on the negative electrode lead surface 1b. Furthermore, the coating film 20 covers the solid-state battery body 10 so as to be in contact with sides (surfaces which connect the principal plane 13a and the principal plane 13b) of the electrolyte layer 13 except the positive electrode lead surface 1a and the negative electrode lead surface 1b.

An insulating coating film 20 having hardness higher than that of the solid electrolytes used in the solid-state battery body 10 is used as the coating film 20 which covers the solid-state battery body 10 so as to expose the portion 11a of the positive electrode layer 11 and the portion 12a of the negative electrode layer 12 on the positive electrode lead surface 1a and the negative electrode lead surface 1b, respectively, of the solid-state battery 1. For example, an insulating coating film 20 having hardness higher than that of the solid electrolyte used in the electrolyte layer 13. Alternatively, an insulating coating film 20 having hardness higher than that of the solid electrolyte used in the electrolyte layer 13, the solid electrolyte used in the positive electrode layer 11, and the solid electrolyte used in the negative electrode layer 12 is used. The insulating property of the coating film 20 is such that lithium ion conduction or electron conduction in the solid-state battery body 10 is not affected or is affected sufficiently slightly. For example, glass or a ceramic is used for forming the insulating coating film 20 having hardness higher than that of the solid electrolytes used in the solid-state battery body 10.

The coating film 20 has the function of protecting the solid-state battery body 10 against force applied from the outside or from an external environment. Accordingly, a coating film which has the above hardness and insulating property, which has low permeability to moisture or gas, such as hydrogen or oxygen, and which realizes good sealability is used as the coating film 20. Furthermore, it is desirable to use as the coating film 20 a coating film having a thermal expansion coefficient which is approximately the same as that of the electrolyte layer 13, the positive electrode layer 11, and the negative electrode layer 12 of the solid-state battery body 10 and to use as the coating film 20 a coating film having good adhesion to each layer. Glass or a ceramic is a kind of material having these properties and is suitable as a material used for forming the coating film 20 which covers the solid-state battery body 10.

For example, the solid-state battery 1 having the above structure is manufactured in accordance with the following procedure. First a structural body is formed. The structural body includes the solid-state battery body 10 having the electrolyte layer 13 and the positive electrode layer 11 and the negative electrode layer 12 laminated on the principal plane 13a and the principal plane 13b, respectively, of the electrolyte layer 13 and a material (referred to as a “coating material”) which covers the solid-state battery body 10 so as to expose the portion 11a of the positive electrode layer 11 and the portion 12a of the negative electrode layer 12 used for electrical connection with the outside. Furthermore, the structural body is burned at a determined temperature (also referred to as a first temperature). The coating material which covers the solid-state battery body 10 is sintered by this burning and the insulating coating film 20 having hardness higher than that of the solid electrolytes used in the solid-state battery body 10 is formed from the coating material.

For example, when this burning is performed, the solid electrolytes used in the solid-state battery body 10 may be sintered and the coating material which covers the solid-state battery body 10 may be sintered. As a result, the coating film 20 is formed. That is to say, materials which are equal or approximately equal in sintering temperature may be used as the solid electrolytes used in the solid-state battery body 10 and the coating material which covers the solid-state battery body 10, and the solid electrolytes and the coating material may be sintered in block by performing burning under one condition.

As stated above, with the solid-state battery 1, the solid-state battery body 10 is covered with the coating film 20 having hardness higher than that of the solid electrolytes used in the solid-state battery body 10 so that the portion 11a of the positive electrode layer 11 will be exposed on the positive electrode lead surface 1a and so that the portion 12a of the negative electrode layer 12 will be exposed on the negative electrode lead surface 1b. The coating film 20 is used as a protection layer of the solid-state battery body 10. This suppresses the appearance of a crack or a chip caused by force applied from the outside, compared with a case where, for example, a solid electrolyte is used as a protection layer. In addition, entrance of moisture or gas through a crack portion or a chip portion is effectively suppressed and deterioration in the performance of the solid-state battery 1, such as a short circuit or an increase in resistance, caused by entrance of moisture or gas is effectively suppressed.

With the solid-state battery 1, part of the above coating film 20 having high hardness is formed on a portion of the principal plane 13a of the electrolyte layer 13 on which the positive electrode layer 11 is not formed and a portion of the principal plane 13b of the electrolyte layer 13 on which the negative electrode layer 12 is not formed, that is to say, on portions of the electrolyte layer 13 which are inwardly depressed from the sides. The coating film 20 is formed on an irregular surface of the solid-state battery body 10. This increases bonding strength between the coating film 20 and the solid-state battery body 10 and effectively suppresses peeling of the coating film 20 off the solid-state battery body 10.

By using the above coating film 20 as a protection layer of the above solid-state battery body 10, the solid-state battery 1 which is excellent in strength and environment resistance is realized.

Furthermore, with the solid-state battery 1 the coating film 20 is formed by the use of a material which is approximately equal in thermal expansion coefficient to each layer of the solid-state battery body 10. This suppresses interlayer peeling caused by expansion and contraction of each layer in an external temperature environment. In addition, with the solid-state battery 1 a coating film having good adhesion to each layer of the solid-state battery body 10 is used as the coating film 20. This suppresses peeling of the coating film 20 off the solid-state battery body 10 which may occur when force is applied from the outside or when each layer expands and contracts. Moreover, with the solid-state battery 1 the coating film 20 is formed by the use of a material sintered at a relatively low temperature, for example, at a temperature equal to or lower than 900° C. For example, the coating film 20 is formed by the use of a material sintered at a temperature equal to or lower than 650° C. This sintering temperature is the same or approximately the same with a solid electrolyte. This suppresses thermal degradation of the solid-state battery body 10 caused by the formation of the coating film 20. Furthermore, an increase in man-hours is suppressed by sintering the coating material and the solid electrolytes in block. By adopting the above coating film 20, the solid-state battery 1 which is excellent in strength and environment resistance is also realized. In addition, the solid-state battery 1 is efficiently manufactured.

(Configuration Example of Solid-State Battery)

A configuration example of a solid-state battery will now be described.

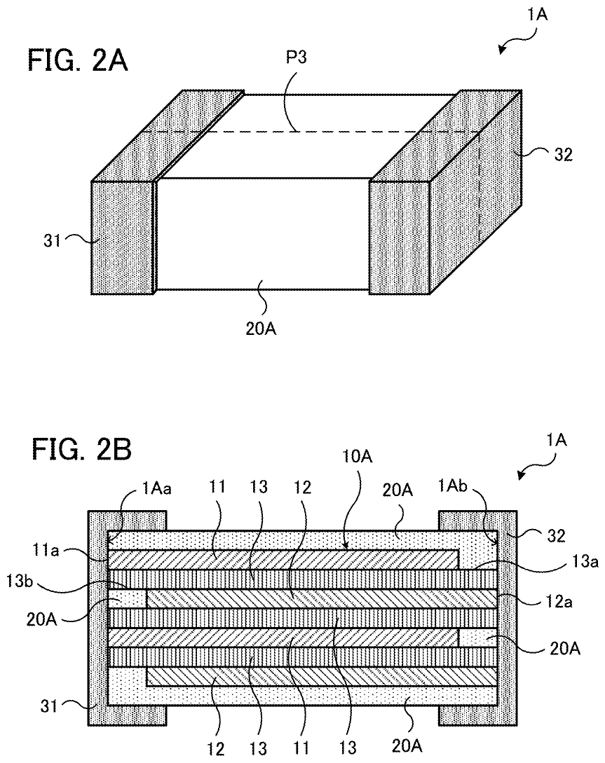

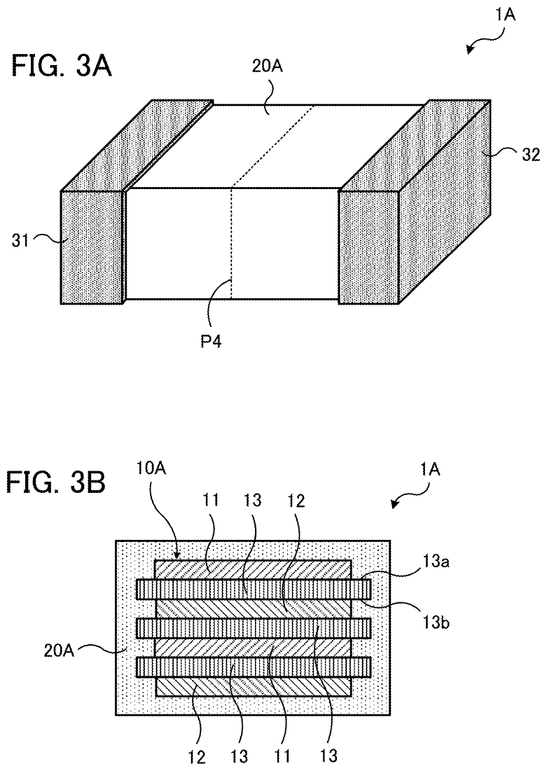

FIGS. 2A and 2B and FIGS. 3A and 3B are views for describing a configuration example of a solid-state battery. FIG. 2A is a fragmentary schematic perspective view of an example of a solid-state battery. FIG. 2B is a schematic sectional view taken along the chain line P3 of FIG. 2A. FIG. 3A is a fragmentary schematic perspective view of the example of the solid-state battery. FIG. 3B is a schematic sectional view taken along the dotted line P4 of FIG. 3A. FIGS. 2A and 2B and FIGS. 3A and 3B are schematic views of the same solid-state battery and are views for describing the structure of sections in different positions of the same solid-state battery.

A solid-state battery 1A illustrated in FIGS. 2A and 2B and FIGS. 3A and 3B is an example of a chip type battery. The solid-state battery 1A includes a solid-state battery body 10A, a coating film 20A, an external electrode 31 (also referred to as a first external electrode), and an external electrode 32 (also referred to as a second external electrode).

As illustrated in FIG. 2B and FIG. 3B, the solid-state battery body 10A includes a plurality of electrolyte layers 13, a plurality of positive electrode layers 11, and a plurality of negative electrode layers 12. The plurality of electrolyte layers 13, the plurality of positive electrode layers 11, and the plurality of negative electrode layers 12 included in the solid-state battery body 10A are laminated so that one electrolyte layer 13 will intervene between a positive electrode layer 11 and a negative electrode layer 12 paired. That is to say, the solid-state battery body 10A in this example has a structure in which a negative electrode layer 12, a electrolyte layer 13, a positive electrode layer 11, a electrolyte layer 13, a negative electrode layer 12, a electrolyte layer 13, and a positive electrode layer 11 are laminated in order from the bottom. In the solid-state battery body 10A, each positive electrode layer 11 is formed on part of a principal plane 13a (also referred to as a first principal plane) of an electrolyte layer 13 on which it is laminated and each negative electrode layer 12 is formed on part of a principal plane 13b (also referred to as a second principal plane) of an electrolyte layer 13 on which it is laminated. A positive electrode layer 11 and a negative electrode layer 12 which are paired opposite each other with an electrolyte layer 13 therebetween are formed so as to overlap each other with the electrolyte layer 13 therebetween. The solid-state battery body 10A is an example of a laminated body in which the plurality of electrolyte layers 13, the plurality of positive electrode layers 11, and the plurality of negative electrode layers 12 are laminated in this way.

For example, an electrolyte layer containing LAGP, which is an oxide solid electrolyte, is used as each electrolyte layer 13 of the solid-state battery body 10A. For example, a positive electrode layer containing LCPO, which is a positive electrode active material, LAGP, which is an oxide solid electrolyte, and a carbon material, which is a conductive assistant, is used as each positive electrode layer 11 of the solid-state battery body 10A. For example, a negative electrode layer containing TiO₂, which is a negative electrode active material, LAGP, which is an oxide solid electrolyte, and a carbon material, which is a conductive assistant, is used as each negative electrode layer 12 of the solid-state battery body 10A.

In the solid-state battery body 10A lithium ions are conducted from a positive electrode layer 11 through an electrolyte layer 13 to a negative electrode layer 12 and are taken in, at charging time. At discharging time, lithium ions are conducted from the negative electrode layer 12 through the electrolyte layer 13 to the positive electrode layer 11 and are taken in. In the solid-state battery body 10A charging and discharging operations are realized by the above lithium ion conduction between the positive electrode layer 11 and the negative electrode layer 12 opposite each other through the electrolyte layer 13 intervening between them.

As illustrated in FIG. 2B, the coating film 20A covers the solid-state battery body 10A so as to expose a portion 11a (also referred to as a first portion) of a side of each positive electrode layer 11 of the solid-state battery body 10A and a portion 12a (also referred to as a second portion) of a side of each negative electrode layer 12 of the solid-state battery body 10A. A side of the solid-state battery 1A on which the portion 11a of the positive electrode layer 11 is exposed from the coating film 20A is a positive electrode lead surface 1Aa and a side of the solid-state battery 1A on which the portion 12a of the negative electrode layer 12 is exposed from the coating film 20A is a negative electrode lead surface 1Ab.

The positive electrode layer 11 is formed on part of the principal plane 13a of the electrolyte layer 13. As illustrated in FIG. 2B and FIG. 3B, the coating film 20A covers the solid-state battery body 10A so as to be in contact with the other part of the principal plane 13a of the electrolyte layer 13 and the surface of the positive electrode layer 11 except the portion 11a exposed on the positive electrode lead surface 1Aa. The negative electrode layer 12 is formed on part of the principal plane 13b of the electrolyte layer 13. The coating film 20A covers the solid-state battery body 10A so as to be in contact with the other part of the principal plane 13b of the electrolyte layer 13 and the surface of the negative electrode layer 12 except the portion 12a exposed on the negative electrode lead surface 1Ab. Furthermore, the coating film 20A covers the solid-state battery body 10A so as to be in contact with sides of the electrolyte layer 13 except the positive electrode lead surface 1Aa and the negative electrode lead surface 1Ab. With the solid-state battery 1A, part of the coating film 20A is formed on a portion of the principal plane 13a of the electrolyte layer 13 on which the positive electrode layer 11 is not formed and a portion of the principal plane 13b of the electrolyte layer 13 on which the negative electrode layer 12 is not formed, that is to say, on portions of the electrolyte layer 13 which are inwardly depressed from the sides.

An insulating coating film 20A having hardness higher than that of the solid electrolyte used in the solid-state battery body 10A is used as the coating film 20A. For example, an insulating coating film 20A having hardness higher than that of the solid electrolyte contained in the electrolyte layer 13 or the solid electrolytes used in the electrolyte layer 13, the positive electrode layer 11, and the negative electrode layer 12 is used as the coating film 20A. A coating film which has high hardness and an insulating property, which has low permeability to moisture or gas, such as hydrogen or oxygen, and which realizes good sealability is used as the coating film 20A. Furthermore, it is desirable to use as the coating film 20A a coating film having a thermal expansion coefficient which is approximately the same as that of each layer included in the solid-state battery body 10A and to use as the coating film 20 a coating film having good adhesion to each layer. Glass, a ceramic, or the like is used for forming the coating film 20A.

As illustrated in FIG. 2B, the external electrode 31 is formed on the positive electrode lead surface 1Aa of the solid-state battery 1A and is connected to the portion 11a of the positive electrode layer 11 of the solid-state battery body 10A exposed on the positive electrode lead surface 1Aa (and part of the sides of the electrolyte layer 13, in this example). As illustrated in FIG. 2B, the external electrode 32 is formed on the negative electrode lead surface 1Ab of the solid-state battery 1A and is connected to the portion 12a of the negative electrode layer 12 of the solid-state battery body 10A exposed on the negative electrode lead surface 1Ab (and part of the sides of the electrolyte layer 13, in this example). The external electrode 31 and the external electrode 32 are formed by the use of various conductor materials. For example, the external electrode 31 and the external electrode 32 are formed by drying and hardening a conductive paste containing conductive particles such as metal particles or carbon particles or depositing various metals by the use of a sputtering method, a plating method, or the like. The metal particles are silver (Ag) particles or the like.

As stated above, with the solid-state battery 1A the solid-state battery body 10A except the positive electrode lead surface 1Aa and the negative electrode lead surface 1Ab is covered with the coating film 20A having hardness higher than that of the solid electrolytes used in the solid-state battery body 10A. This suppresses the appearance of a crack or a chip in the coating film 20A caused by force applied from the outside. In addition, entrance of moisture or gas through a crack portion or a chip portion is effectively suppressed and deterioration in the performance of the solid-state battery 1A, such as a short circuit or an increase in resistance, caused by entrance of moisture or gas is effectively suppressed.

With the solid-state battery 1A part of the coating film 20A is formed on the portions of the electrolyte layer 13 which are inwardly depressed from the sides. As a result, an anchor effect is obtained. This effectively suppresses peeling of the coating film 20A off the solid-state battery body 10A.

Furthermore, part of the coating film 20A is formed in a portion in the positive electrode lead surface 1Aa inwardly depressed from the sides of the electrolyte layers 13 which are paired opposite each other with the negative electrode layer 12 therebetween. This enhances strength between the electrolyte layers 13 paired and strengthens the support of the positive electrode layers 11 laminated on the electrolyte layers 13. As a result, the strength of the positive electrode layers 11 on the positive electrode lead surface 1Aa is enhanced and the appearance of a crack or a chip is suppressed. Similarly, part of the coating film 20A is formed in a portion in the negative electrode lead surface 1Ab inwardly depressed from the sides of the electrolyte layers 13 which are paired opposite each other with the positive electrode layer 11 therebetween. This enhances strength between the electrolyte layers 13 paired and strengthens the support of the negative electrode layers 12 laminated on the electrolyte layers 13. As a result, the strength of the negative electrode layers 12 on the negative electrode lead surface 1Ab is enhanced and the appearance of a crack or a chip is suppressed.

By using the above coating film 20A as a protection layer of the above solid-state battery body 10A, the solid-state battery 1A which is excellent in strength and environment resistance is realized.

Furthermore, with the solid-state battery 1A the coating film 20A is formed by the use of a material which is approximately equal in thermal expansion coefficient to each layer of the solid-state battery body 10A. This suppresses interlayer peeling caused by expansion and contraction of each layer in an external temperature environment. In addition, with the solid-state battery 1A a coating film having good adhesion to each layer of the solid-state battery body 10A is used as the coating film 20A. This suppresses peeling of the coating film 20A off the solid-state battery body 10A which may occur when force is applied from the outside or when each layer expands and contracts. By using this coating film 20A, the solid-state battery 1A which is excellent in strength and environment resistance is also realized.

For example, to manufacture the solid-state battery 1A, first a structural body is formed. The structural body includes the solid-state battery body 10A having the electrolyte layer 13 and the positive electrode layer 11 and the negative electrode layer 12 laminated on the principal plane 13a and the principal plane 13b, respectively, of the electrolyte layer 13 and a coating material which covers the solid-state battery body 10A so as to expose the portion 11a of the positive electrode layer 11 and the portion 12a of the negative electrode layer 12 connected to the external electrode 31 and the external electrode 32 respectively. Furthermore, the structural body is burned at a determined temperature (also referred to as a first temperature). By doing so, the coating material which covers the solid-state battery body 10A is sintered and the coating film 20A is formed. If a material sintered at a relatively low temperature, for example, at a temperature equal to or lower than 900° C. is used as the coating material, for example, if a material sintered at a temperature equal to or lower than 650° C. is used as the coating material, then thermal degradation of the solid-state battery body 10A caused by the formation of the coating film 20A is suppressed. In addition, if a material which is equal or approximately equal in sintering temperature to the solid electrolytes used in the solid-state battery body 10A is used as the coating material, then the solid electrolytes and the coating material are sintered in block by performing burning under one condition. The details of a method for manufacturing the solid-state battery 1A will be described later.

Glass, a ceramic, or the like is used as the coating film 20A formed by burning the coating material. The coating film 20A may take various forms. For example, the coating film 20A may take the form of glass, crystalline glass, polycrystalline, a single crystal, or the like. The coating film 20A may contain one material phase or two or more material phases. The coating film 20A may contain two or more material phases which differ in physical property, for example, which differ in hardness.

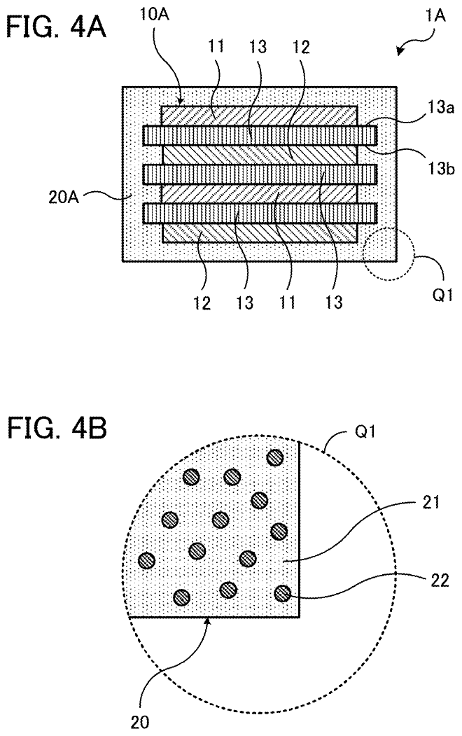

FIGS. 4A and 4B are views for describing an example of a coating film of a solid-state battery. FIG. 4A is a fragmentary schematic sectional view of an example of a solid-state battery (taken along the dotted line P4 of FIG. 3A). FIG. 4B is a schematic enlarged view of the portion Q1 of FIG. 4A.

As illustrated in FIG. 4B, for example, the coating film 20A of FIG. 4A which covers the solid-state battery body 10A of the solid-state battery 1A may contain a material phase 21 (also referred to as a first material phase) and a material phase 22 (also referred to as a second material phase). For example, the coating film 20A contains the material phase 21 of glass or a ceramic having a determined hardness (also referred to as a first hardness) and the material phase 22 having hardness (also referred to as a second hardness) higher than that of the material phase 21. For example, a ceramic is used as the material phase 22 having hardness higher than that of the material phase 21. For example, aluminum oxide (Al₂O₃) is used as the material phase 22 which is a ceramic. For example, the material phase 22 is contained in the material phase 21 in the form of particles illustrated in FIG. 4B. The material phase 22 in the form of particles is not always contained in the material phase 21 in a uniformly dispersed state. Furthermore, FIG. 4B illustrates the material phase 22 in the form of particles. However, a material phase in the form of a fiber or a sheet having hardness higher than that of the material phase 21 or a material phase in more than one form may be contained in the material phase 21.

The coating film 20A contains the material phase 21 of glass or a ceramic in which the material phase 22 having hardness higher than that of the material phase 21 is contained. By adopting this coating film 20A, hardness as the coating film 20A is enhanced further, compared with a case where the coating film 20A contains only the material phase 21. Because the solid-state battery body 10A is covered with this coating film 20A, the solid-state battery 1A which is excellent in strength and environment resistance is realized.

(Solid-State Battery Manufacturing Method)

A method for manufacturing a solid-state battery having the above structure will now be described.

First an example of the formation of each of an electrolyte paste, a positive electrode paste, a negative electrode paste, and a coating material paste and a coating material sheet will be described.

(Electrolyte Paste)

An electrolyte paste containing a solid electrolyte, a binder, a plasticizer, a dispersant, and a diluent is prepared. For example, an electrolyte paste containing LAGP, which is an oxide solid electrolyte, as a solid electrolyte is prepared.

(Positive Electrode Paste)

A positive electrode paste containing a positive electrode active material, a solid electrolyte, a conductive assistant, a binder, a plasticizer, a dispersant, and a diluent is prepared. For example, a positive electrode paste containing LCPO as a positive electrode active material, LAGP, which is an oxide solid electrolyte, as a solid electrolyte, and a carbon nanofiber as a conductive assistant is prepared.

(Negative Electrode Paste)

A negative electrode paste containing a negative electrode active material, a solid electrolyte, a conductive assistant, a binder, a plasticizer, a dispersant, and a diluent is prepared. For example, a negative electrode paste containing TiO₂ as a negative electrode active material, LAGP, which is an oxide solid electrolyte, as a solid electrolyte, and a carbon nanofiber as a conductive assistant is prepared.

(Coating Material Paste and Coating Material Sheet)

A glass paste containing a glass component is prepared as a coating material paste. For example, a glass paste containing a glass component referred to as low melting point glass melted and sintered by performing burning at a temperature of about 600° C. is prepared. By painting and drying the prepared glass paste, a glass sheet as a coating material sheet is formed. A coating material paste and a coating material sheet are a form of a coating material formed as the coating film 20A by burning.

A material having hardness after burning higher than that of the solid electrolytes contained in the electrolyte layer 13, the positive electrode layer 11, and the negative electrode layer 12 after burning is used as a coating material paste and a coating material sheet. Furthermore, it is desirable to use as a coating material paste and a coating material sheet a material after burning which is approximately equal in thermal expansion coefficient to the electrolyte layer 13, the positive electrode layer 11, and the negative electrode layer 12 after burning. In addition, it is desirable to use as a coating material paste and a coating material sheet a material after burning which has good adhesion to the electrolyte layer 13, the positive electrode layer 11, and the negative electrode layer 12 after burning. Moreover, a ceramic material, such as Al₂O₃ in the form of particles, may be added to a coating material paste and a coating material sheet. In this case, a glass component contained in the coating material paste and the coating material sheet is a first material phase and the ceramic material, such as Al₂O₃ in the form of particles, is a second material phase.

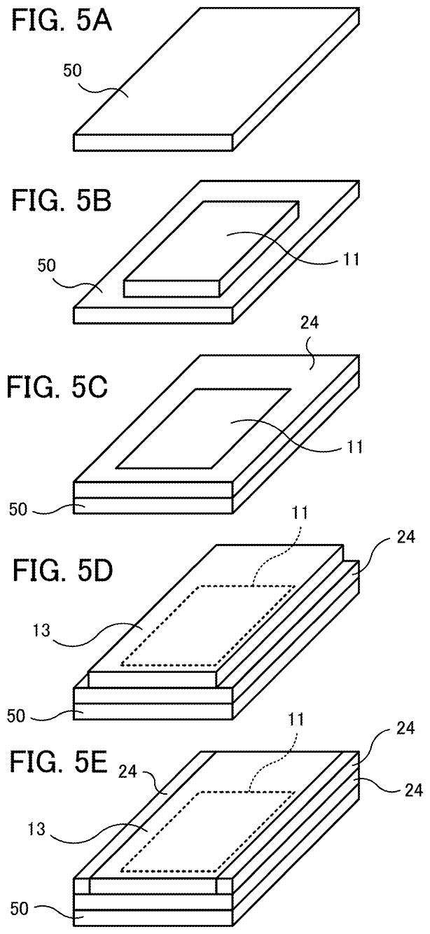

A first example of forming a structural body by the use of the electrolyte paste, the positive electrode paste, the negative electrode paste, and the coating material paste and the coating material sheet prepared in the above way will now be described by reference to FIGS. 5A through 9B.

### First Example

(Formation of Positive Electrode Layer Part)

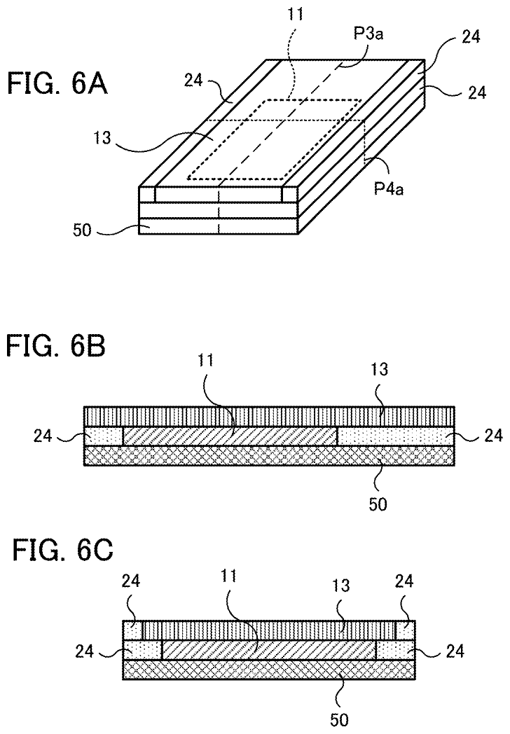

FIGS. 5A through 5E and FIGS. 6A through 6C are views for describing an example of a positive electrode layer part formation process. FIG. 5A is a fragmentary schematic perspective view of an example of a support preparation subprocess. FIG. 5B is a fragmentary schematic perspective view of an example of a positive electrode layer formation subprocess. FIG. 5C is a fragmentary schematic perspective view of an example of a first coating material layer formation subprocess. FIG. 5D is a fragmentary schematic perspective view of an example of an electrolyte layer formation subprocess. FIG. 5E is a fragmentary schematic perspective view of an example of a second coating material layer formation subprocess. Furthermore, FIG. 6A corresponds to FIG. 5E and is a fragmentary schematic perspective view of an example of a positive electrode layer part. FIG. 6B is a schematic sectional view taken along the chain line P3a of FIG. 6A. FIG. 6C is a schematic sectional view taken along the dotted line P4a of FIG. 6A.

For example, a polyethylene terephthalate (PET) film is used as a support 50 illustrated in FIG. 5A. As illustrated in FIG. 5B, part of the prepared support 50 illustrated in FIG. 5A is coated with the positive electrode paste by the use of a screen printing method, the positive electrode paste is dried, and the positive electrode layer 11 is formed. As illustrated in FIG. 5C, after the positive electrode layer 11 is formed, the periphery of the positive electrode layer 11 formed on the part of the support 50 is coated with the coating material paste by the use of the screen printing method. The coating material paste is dried and a coating material layer 24 is formed. The coating material layer 24 is also referred to as a buried layer.

Next, as illustrated in FIG. 5D, the positive electrode layer 11 and part of the coating material layer 24 formed therearound are coated with the electrolyte paste by the use of the screen printing method. The electrolyte paste is dried and the electrolyte layer 13 is formed. As illustrated in FIG. 5E, after the electrolyte layer 13 is formed, part of the coating material layer 24 which is not covered with the electrolyte layer 13 is coated with the coating material paste by the use of the screen printing method. The coating material paste is dried and a coating material layer 24 (buried layer) is formed.

For example, by performing the subprocesses illustrated in FIGS. 5A through 5E, a part having a sectional structure illustrated in FIG. 6B in the position of the chain line P3a of FIG. 6A and having a sectional structure illustrated in FIG. 6C in the position of the dotted line P4a of FIG. 6A is formed. The part illustrated in FIGS. 6A through 6C (and FIG. 5E) is used as a positive electrode layer part. Furthermore, the support 50 is peeled from the part illustrated in FIGS. 6A through 6C and the remainder may be used as a positive electrode layer part. In addition, a part before the formation of the electrolyte layer 13 illustrated in FIG. 5C or the remainder after peeling the support 50 from this part may be used as a positive electrode layer part.

When the positive electrode layer part is formed, coating the support 50 with the positive electrode paste and coating the periphery of the positive electrode layer 11 with the coating material paste may be performed alternately and repetitively more than one time in order to, for example, adjust the thickness of the positive electrode layer 11 and the amount of the active material. In this case, drying the positive electrode paste and drying the coating material paste may be performed each time after coating. Alternatively, drying the positive electrode paste and drying the coating material paste may be performed in block after coating the support 50 with the positive electrode paste and coating the periphery of the positive electrode layer 11 with the coating material paste are performed more than one time.

Furthermore, when the positive electrode layer part is formed, coating the positive electrode layer 11 and the part of the coating material layer 24 formed therearound with the electrolyte paste and coating the part of the coating material layer 24 with the coating material paste may be performed alternately and repetitively more than one time in order to, for example, adjust the thickness of the electrolyte layer 13. In this case, drying the electrolyte paste and drying the coating material paste may be performed each time after coating. Alternatively, drying the electrolyte paste and drying the coating material paste may be performed in block after coating the positive electrode layer 11 and the part of the coating material layer 24 formed therearound with the electrolyte paste and coating the part of the coating material layer 24 with the coating material paste are performed more than one time.

In addition, in the example illustrated in FIGS. 5A through 5E and FIGS. 6A through 6C, the positive electrode layer 11 and the peripheral coating material layer 24 are formed on the support 50. After that, the electrolyte layer 13 and the outer coating material layer 24 are formed. However, this order may be reversed. That is to say, in accordance with the above example, the electrolyte layer 13 and the outer coating material layer 24 are formed on the support 50. After that, the positive electrode layer 11 and the peripheral coating material layer 24 may be formed.

(Formation of Negative Electrode Layer Part)

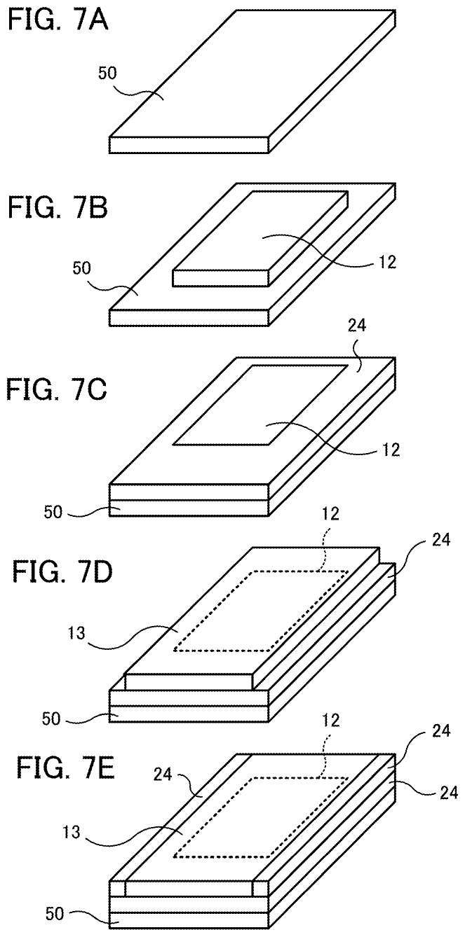

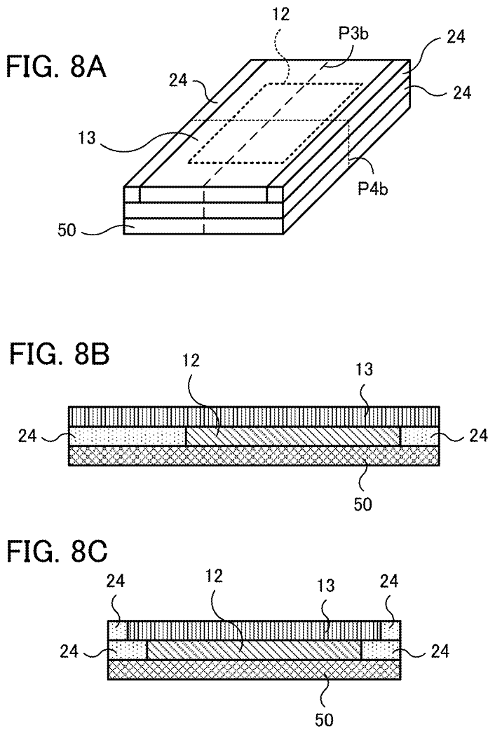

FIGS. 7A through 7E and FIGS. 8A through 8C are views for describing an example of a negative electrode layer part formation process. FIG. 7A is a fragmentary schematic perspective view of an example of a support preparation subprocess. FIG. 7B is a fragmentary schematic perspective view of an example of a negative electrode layer formation subprocess. FIG. 7C is a fragmentary schematic perspective view of an example of a first coating material layer formation subprocess. FIG. 7D is a fragmentary schematic perspective view of an example of an electrolyte layer formation subprocess. FIG. 7E is a fragmentary schematic perspective view of an example of a second coating material layer formation subprocess. Furthermore, FIG. 8A corresponds to FIG. 7E and is a fragmentary schematic perspective view of an example of a negative electrode layer part. FIG. 8B is a schematic sectional view taken along the chain line P3b of FIG. 8A. FIG. 8C is a schematic sectional view taken along the dotted line P4b of FIG. 8A.

As illustrated in FIG. 7B, part of a support 50, such as a PET film, illustrated in FIG. 7A is coated with the negative electrode paste by the use of the screen printing method, the negative electrode paste is dried, and the negative electrode layer 12 is formed. As illustrated in FIG. 7C, after the negative electrode layer 12 is formed, the periphery of the negative electrode layer 12 formed on the part of the support 50 is coated with the coating material paste by the use of the screen printing method. The coating material paste is dried and a coating material layer 24 (buried layer) is formed.

Next, as illustrated in FIG. 7D, the negative electrode layer 12 and part of the coating material layer 24 formed therearound are coated with the electrolyte paste by the use of the screen printing method. The electrolyte paste is dried and the electrolyte layer 13 is formed. As illustrated in FIG. 7E, after the electrolyte layer 13 is formed, part of the coating material layer 24 which is not covered with the electrolyte layer 13 is coated with the coating material paste by the use of the screen printing method. The coating material paste is dried and a coating material layer 24 (buried layer) is formed.

For example, by performing the subprocesses illustrated in FIGS. 7A through 7E, a part having a sectional structure illustrated in FIG. 8B in the position of the chain line P3b of FIG. 8A and having a sectional structure illustrated in FIG. 8C in the position of the dotted line P4b of FIG. 8A is formed. The part illustrated in FIGS. 8A through 8C (and FIG. 7E) is used as a negative electrode layer part. Furthermore, the remainder after peeling the support 50 from the part illustrated in FIGS. 8A through 8C may be used as a negative electrode layer part. In addition, a part before the formation of the electrolyte layer 13 illustrated in FIG. 7C or the remainder after peeling the support 50 from this part may be used as a negative electrode layer part.

When the negative electrode layer part is formed, coating the support 50 with the negative electrode paste and coating the periphery of the negative electrode layer 12 with the coating material paste may be performed alternately and repetitively more than one time in order to, for example, adjust the thickness of the negative electrode layer 12 and the amount of the active material. In this case, drying the negative electrode paste and drying the coating material paste may be performed each time after coating. Alternatively, drying the negative electrode paste and drying the coating material paste may be performed in block after coating the support 50 with the negative electrode paste and coating the periphery of the negative electrode layer 12 with the coating material paste are performed more than one time.

Furthermore, when the negative electrode layer part is formed, coating the negative electrode layer 12 and the part of the coating material layer 24 formed therearound with the electrolyte paste and coating the part of the coating material layer 24 with the coating material paste may be performed alternately and repetitively more than one time in order to, for example, adjust the thickness of the electrolyte layer 13. In this case, drying the electrolyte paste and drying the coating material paste may be performed each time after coating. Alternatively, drying the electrolyte paste and drying the coating material paste may be performed in block after coating the negative electrode layer 12 and the part of the coating material layer 24 formed therearound with the electrolyte paste and coating the part of the coating material layer 24 with the coating material paste are performed more than one time.

In addition, in the example illustrated in FIGS. 7A through 7E and FIGS. 8A through 8C, the negative electrode layer 12 and the peripheral coating material layer 24 are formed on the support 50. After that, the electrolyte layer 13 and the outer coating material layer 24 are formed. However, this order may be reversed. That is to say, in accordance with the above example, the electrolyte layer 13 and the outer coating material layer 24 are formed on the support 50. After that, the negative electrode layer 12 and the peripheral coating material layer 24 may be formed.

(Formation of Structural Body)

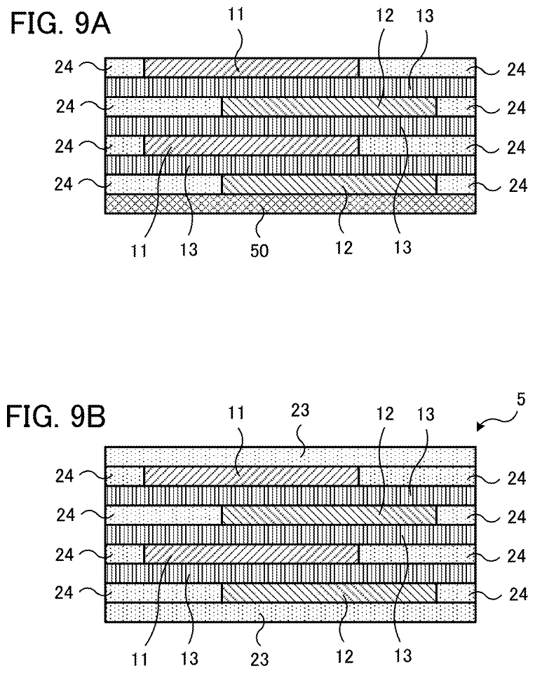

FIGS. 9A and 9B are views for describing an example of a structural body formation process. FIG. 9A is a fragmentary schematic sectional view of an example of a part group laminating subprocess. FIG. 9B is a fragmentary schematic sectional view of an example of a coating material sheet laminating subprocess. FIGS. 9A and 9B schematically illustrate a section of a part group corresponding to the positions of the chain line P3a of FIG. 6A and the chain line P3b of FIG. 8A.

For example, the positive electrode layer part in a determined form and the negative electrode layer part in a determined form obtained in the above way are laminated in a way illustrated in FIG. 9A. In this example, the remainder after peeling the support 50 from the positive electrode layer part illustrated in FIG. 6B is laminated on the negative electrode layer part with the support 50 illustrated in FIG. 8B. The remainder after peeling the support 50 from the negative electrode layer part illustrated in FIG. 8B is laminated on the remainder after peeling the support 50 from the positive electrode layer part illustrated in FIG. 6B. The remainder after peeling the support 50 from the positive electrode layer part illustrated in FIG. 5C is laminated on the remainder after peeling the support 50 from the negative electrode layer part illustrated in FIG. 8B. Furthermore, the support 50 is peeled from a structure illustrated in FIG. 9A and a coating material sheet 23 is laminated on the bottom layer and the top layer. Alternatively, a coating material sheet 23 is formed on the bottom layer and the top layer by the use of the coating material paste. These are thermally pressure-bonded at a determined pressure and a determined temperature. As a result, a structural body 5 illustrated in FIG. 9B is formed.

When the structural body 5 is formed in this way, the positive electrode layer part and the negative electrode layer part are laminated so that the negative electrode layer 12 and the positive electrode layer 11 opposite each other with the electrolyte layer 13 therebetween will overlap in the section illustrated in FIGS. 9A and 9B. Alternatively, in the positive electrode layer part formation process and the negative electrode layer part formation process, coating is performed so that when the positive electrode layer part and the negative electrode layer part are laminated, a positional relationship by which the negative electrode layer 12 and the positive electrode layer 11 opposite each other with the electrolyte layer 13 therebetween overlap is realized in the section illustrated in FIGS. 9A and 9B.

The positive electrode layer part and the negative electrode layer part are laminated so that one of the negative electrode layer 12 and the positive electrode layer 11 opposite each other with the electrolyte layer 13 therebetween will wholly be superimposed over the other is realized in a section perpendicular to the section illustrated in FIGS. 9A and 9B. Alternatively, in the positive electrode layer part formation process and the negative electrode layer part formation process, coating is performed so that when the positive electrode layer part and the negative electrode layer part are laminated, a positional relationship by which one of the negative electrode layer 12 and the positive electrode layer 11 opposite each other with the electrolyte layer 13 therebetween will wholly be superimposed over the other is realized in a section perpendicular to the section illustrated in FIGS. 9A and 9B.

By performing the process illustrated in FIGS. 9A and 9B, for example, the structural body 5 including a laminated body (basic structure of the above solid-state battery body 10A) having the positive electrode layer 11, the negative electrode layer 12, and the electrolyte layer 13 intervening therebetween and the coating material sheet 23 and the coating material layer 24 (basic structure of the above coating film 20A) formed so as to cover the laminated body is formed.

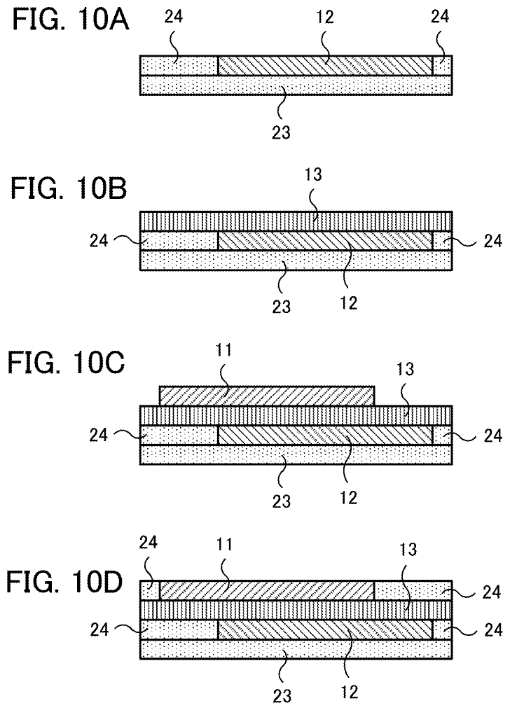

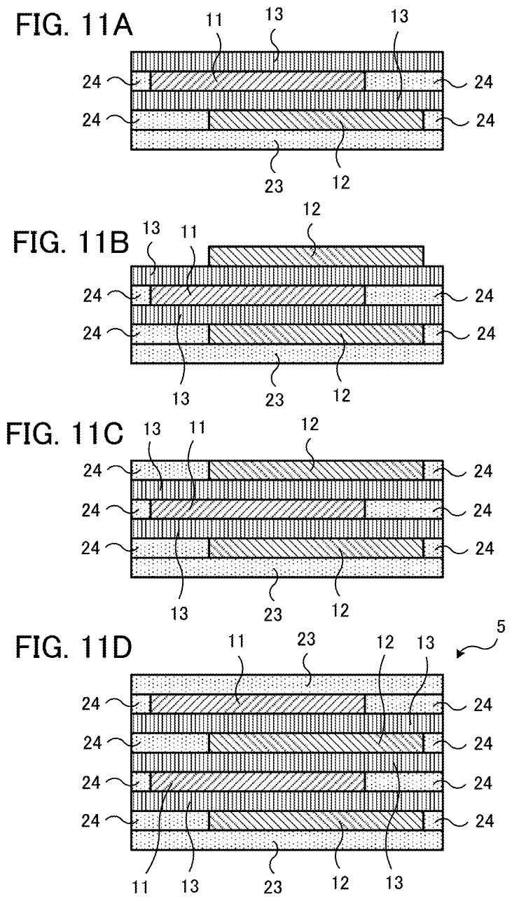

A second example of forming a structural body by the use of the electrolyte paste, the positive electrode paste, the negative electrode paste, and the coating material paste and the coating material sheet prepared in the above way will now be described by reference to FIGS. 10A through 10D and FIGS. 11A through 11D.

### Second Example

FIG. 10 and FIG. 11 are views for describing another example of a structural body formation process. Each of FIGS. 10A through 10D and FIGS. 11A through 11D is a fragmentary schematic sectional view of an example of a structural body formation subprocess.

In the second example, as illustrated in FIG. 10A, first part of the coating material sheet 23 is coated with the negative electrode paste. The negative electrode paste is dried and the negative electrode layer 12 is formed. After that, as illustrated in FIG. 10A, the periphery of the negative electrode layer 12 formed on the part of the coating material sheet 23 is coated with the coating material paste, the coating material paste is dried, and a coating material layer 24 (buried layer) is formed.

Next, as illustrated in FIG. 10B, the negative electrode layer 12 and part of the peripheral coating material layer 24 are coated with the electrolyte paste, the electrolyte paste is dried, and the electrolyte layer 13 is formed. After the electrolyte layer 13 is formed, part of the coating material layer 24 not covered with the electrolyte layer 13 is coated with the coating material paste by the use of the screen printing method, the coating material paste is dried, and a coating material layer 24 (buried layer) is formed (not illustrated). Furthermore, as illustrated in FIG. 10C, part of the electrolyte layer 13 is coated with the positive electrode paste, the positive electrode paste is dried, and the positive electrode layer 11 is formed. After that, as illustrated in FIG. 10D, the periphery of the positive electrode layer 11 formed on the part of the electrolyte layer 13 is coated with the coating material paste, the coating material paste is dried, and a coating material layer 24 (buried layer) is formed.

Next, as illustrated in FIG. 11A, the positive electrode layer 11 and part of the peripheral coating material layer 24 are coated with the electrolyte paste, the electrolyte paste is dried, and the electrolyte layer 13 is formed. After the electrolyte layer 13 is formed, part of the coating material layer 24 not covered with the electrolyte layer 13 is coated with the coating material paste by the use of the screen printing method, the coating material paste is dried, and a coating material layer 24 (buried layer) is formed (not illustrated). Furthermore, as illustrated in FIG. 11B, part of the electrolyte layer 13 is coated with the negative electrode paste, the negative electrode paste is dried, and the negative electrode layer 12 is formed. After that, as illustrated in FIG. 11C, the periphery of the negative electrode layer 12 formed on the part of the electrolyte layer 13 is coated with the coating material paste, the coating material paste is dried, and a coating material layer 24 (buried layer) is formed.

After that, as illustrated in FIG. 11D, the electrolyte layer 13 is formed by the use of the electrolyte paste on the negative electrode layer 12 and part of the peripheral coating material layer 24 in accordance with the same procedure that is described above. Furthermore, a coating material layer 24 (buried layer) is formed (not illustrated) by the use of the coating material paste outside the electrolyte layer 13 and the positive electrode layer 11 is formed on part of the electrolyte layer 13 by the use of the positive electrode paste. In addition, a coating material layer 24 (buried layer) is formed by the use of the coating material paste around the positive electrode layer 11 formed on the part of the electrolyte layer 13. Moreover, a coating material sheet 23 is formed by the use of the coating material paste on the positive electrode layer 11 and the coating material layer 24 therearound. Alternatively, a coating material sheet 23 prepared in advance is laminated on the positive electrode layer 11 and the coating material layer 24 therearound. As a result, a structural body 5 illustrated in FIG. 11D is formed.

Coating the coating material sheet 23 with the negative electrode paste and the coating material paste (FIG. 10A) and coating the electrolyte layer 13 with the negative electrode paste and the coating material paste (FIG. 11B and FIG. 11C respectively) may be performed alternately and repetitively more than one time in order to, for example, adjust the thickness of the negative electrode layer 12 and the amount of the active material. In this case, drying the negative electrode paste and drying the coating material paste may be performed each time after coating. Alternatively, drying the negative electrode paste and drying the coating material paste may be performed in block after coating the coating material sheet 23 with the negative electrode paste and the coating material paste and coating the electrolyte layer 13 with the negative electrode paste and the coating material paste are performed more than one time.

Furthermore, coating the electrolyte layer 13 with the positive electrode paste (FIG. 10C and FIG. 11D) and the coating material paste (FIG. 10D and FIG. 11D) may be performed alternately and repetitively more than one time in order to, for example, adjust the thickness of the positive electrode layer 11 and the amount of the active material. In this case, drying the positive electrode paste and drying the coating material paste may be performed each time after coating. Alternatively, drying the positive electrode paste and drying the coating material paste may be performed in block after coating the electrolyte layer 13 with the positive electrode paste and the coating material paste are performed more than one time.

By performing the process illustrated in FIGS. 10A through 10D and FIGS. 11A through 11D, for example, the structural body 5 including a laminated body (basic structure of the above solid-state battery body 10A) having the positive electrode layer 11, the negative electrode layer 12, and the electrolyte layer 13 intervening therebetween and the coating material sheet 23 and the coating material layer 24 (basic structure of the above coating film 20A) formed so as to cover the laminated body may be formed.

(Cutting of Structural Body)

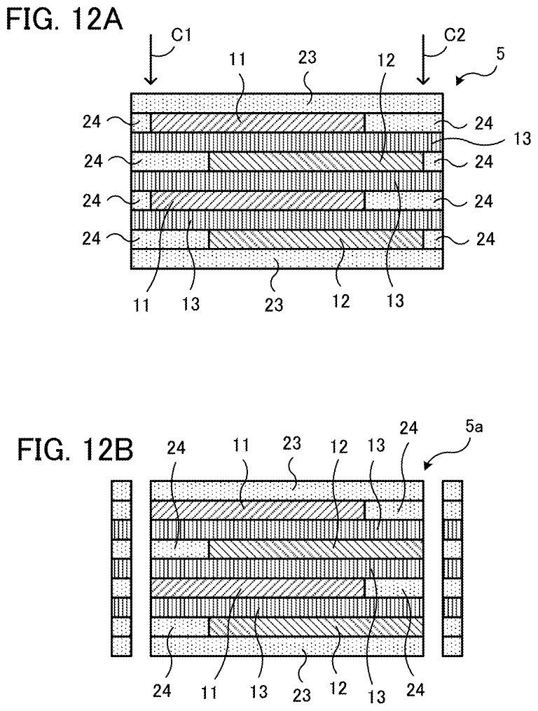

FIGS. 12A and 12B are views for describing an example of a structural body cutting process. FIGS. 12A and 12B are fragmentary schematic sectional views of an example of a structural body cutting process.

The structural body 5 formed by the method described in the above first example (FIGS. 5A through 9B) or in the above second example (FIGS. 10A through 10D and FIGS. 11A through 11D) is cut in the determined positions C1 and C2 illustrated in FIG. 12A. The structural body 5 is cut in the position C1 in which an end surface of each positive electrode layer 11 gets exposed in one section and in the position C2 in which an end surface of each negative electrode layer 12 gets exposed in the other section. By cutting the structural body 5 in the above positions C1 and C2, a structural body 5a illustrated in FIG. 12B and having a section in which an end surface of each positive electrode layer 11 is exposed and a section in which an end surface of each negative electrode layer 12 is exposed is formed. The section of the structural body 5a in which an end surface of each positive electrode layer 11 is exposed and the section of the structural body 5a in which an end surface of each negative electrode layer 12 is exposed are the positive electrode lead surface 1Aa and the negative electrode lead surface 1Ab, respectively, described later.

(Heat Treatment of Structural Body)

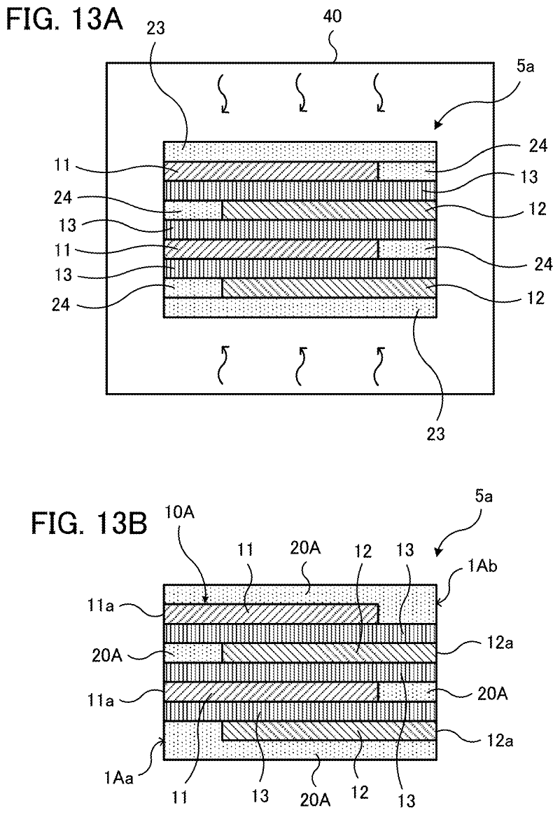

FIGS. 13A and 13B are views for describing an example of a structural body heat treatment process. FIGS. 13A and 13B are fragmentary schematic sectional views of an example of a structural body heat treatment process.

As illustrated in FIG. 13A, the structural body 5a obtained by the cutting is transported into a heat treatment furnace 40 and heat treatment is performed under determined conditions including an atmosphere, temperature, and time. For example, the structural body 5a transported into the heat treatment furnace 40 is heat-treated mainly for removing grease by burning down an organic component, such as a binder, and mainly for burning, that is to say, mainly for sintering the solid electrolytes and the coating material. For example, heat treatment for removing grease is performed under the condition that the structural body 5a is held for ten hours at a temperature of 500° C. in an atmosphere containing oxygen. Heat treatment for burning is performed under the condition that the structural body 5a is held for two hours at a temperature of 600° C. in an atmosphere containing nitrogen or oxygen. If a material which is equal or approximately equal in sintering temperature to the solid electrolytes contained in the structural body 5a is used as the coating material, then the solid electrolytes and the coating material are sintered in block by performing burning under one condition.

The solid electrolyte contained in the electrolyte layer 13 of the structural body 5a is sintered by the heat treatment for burning. Furthermore, the solid electrolytes contained in the positive electrode layer 11 and the negative electrode layer 12 of the structural body 5a are sintered. As a result, the solid-state battery body 10A illustrated in FIG. 13B and having the positive electrode layer 11, the negative electrode layer 12, and the electrolyte layer 13 intervening therebetween is formed.

In addition, as a result of the heat treatment for burning, the coating material contained in the coating material sheet 23 and the coating material layer 24 of the structural body 5a is sintered and the coating material sheet 23 incorporates with the coating material layer 24. As a result, the insulating coating film 20A illustrated in FIG. 13B which covers the solid-state battery body 10A and which has hardness higher than that of the solid electrolytes after burning contained in the solid-state battery body 10A is formed from the coating material sheet 23 and the coating material layer 24.

The coating film 20A formed by the burning may take various forms. For example, the coating film 20A formed by the burning may take the form of glass, crystalline glass, a polycrystal, or a single crystal. The coating film 20A may contain one phase or may contain two or more phases which differ in physical property. If a ceramic material, such as Al₂O₃ in the form of particles, is added to a coating material for the coating film 20A, then the coating film 20A having high hardness may be formed compared with a case where a coating material to which a ceramic material is not added is used. The coating film 20A is bonded to the electrolyte layer 13, the positive electrode layer 11, and the negative electrode layer 12 of the solid-state battery body 10A by this heat treatment. The coating film 20A obtained by the burning may have a thermal expansion coefficient which is approximately the same as that of each layer of the solid-state battery body 10A and may have good adhesion to each layer of the solid-state battery body 10A, depending on the characteristics of a coating material used for forming the coating film 20A.

A section of the structural body 5a illustrated in FIG. 13B in which an end surface of each positive electrode layer 11 is exposed, that is to say, the section obtained by performing cutting in the above position C1 is the positive electrode lead surface 1Aa. An end surface of each positive electrode layer 11 exposed on the positive electrode lead surface 1Aa is the portion 11a connected to the external electrode 31. A section of the structural body 5a illustrated in FIG. 13B in which an end surface of each negative electrode layer 12 is exposed, that is to say, the section obtained by performing cutting in the above position C2 is the negative electrode lead surface 1Ab. An end surface of each negative electrode layer 12 exposed on the negative electrode lead surface 1Ab is the portion 12a connected to the external electrode 32.

After the heat treatment is performed, the external electrode 31 is formed on the positive electrode lead surface 1Aa of the structural body 5a and the external electrode 32 is formed on the negative electrode lead surface 1Ab of the structural body 5a. For example, the external electrode 31 and the external electrode 32 are formed on the positive electrode lead surface 1Aa and the negative electrode lead surface 1Ab, respectively, of the structural body 5a after the heat treatment by the use of a method in which the positive electrode lead surface 1Aa and the negative electrode lead surface 1Ab are coated with a conductive paste, the conductive paste is dried, and the conductive paste is hardened or a method in which metal is deposited by sputtering, plating, or the like. By doing so, the solid-state battery 1A illustrated in FIG. 2A and FIG. 2B (and FIG. 3A and FIG. 3B) is obtained.

With the solid-state battery 1A the solid-state battery body 10A except the positive electrode lead surface 1Aa and the negative electrode lead surface 1Ab is covered with the coating film 20A having hardness higher than that of the solid electrolytes used in the solid-state battery body 10A. This effectively suppresses the appearance of a crack or a chip in the coating film 20A, entrance of moisture or gas caused by the appearance of a crack or a chip, or deterioration in the performance of the solid-state battery 1A caused by entrance of moisture or gas. Furthermore, with the solid-state battery 1A part of the coating film 20A is formed as buried layers on the portions of the electrolyte layer 13 which are inwardly depressed from the sides. This effectively suppresses peeling of the coating film 20A by an anchor effect and enhances the support and strength of each positive electrode layer 11 on the positive electrode lead surface 1Aa and each negative electrode layer 12 on the negative electrode lead surface 1Ab.

The solid-state battery 1A which is excellent in strength and environment resistance is manufactured by the above method.

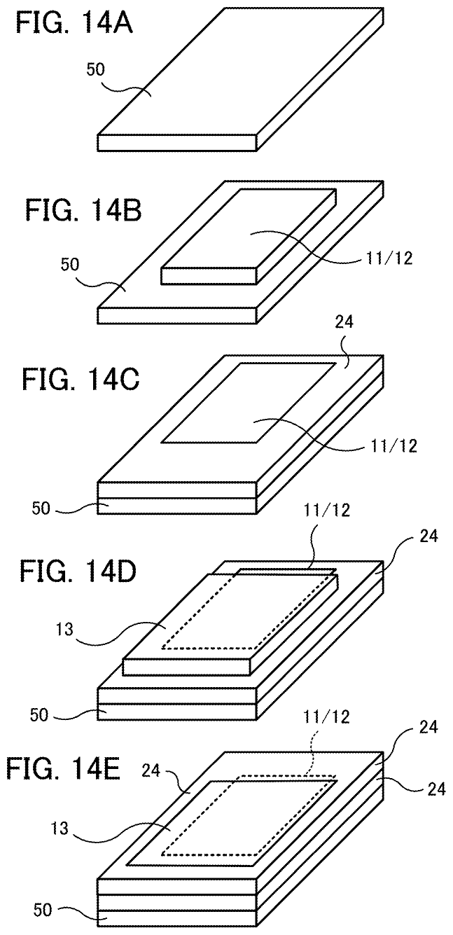

In order to manufacture a solid-state battery, a method illustrated in FIGS. 14A through 16C may be adopted.

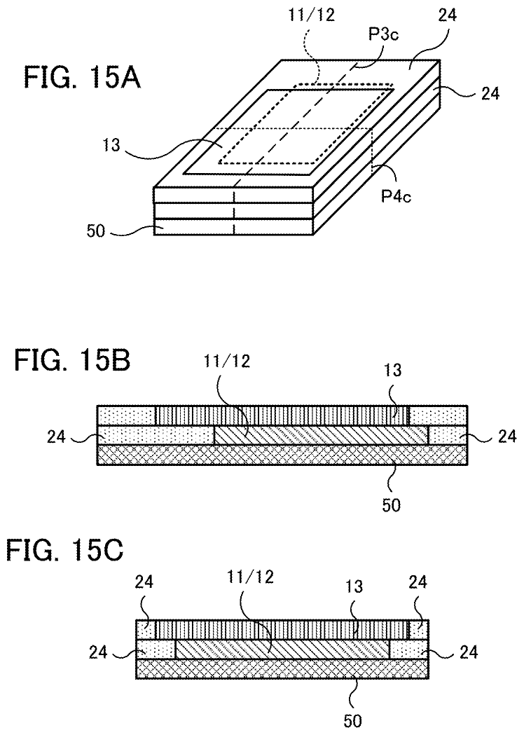

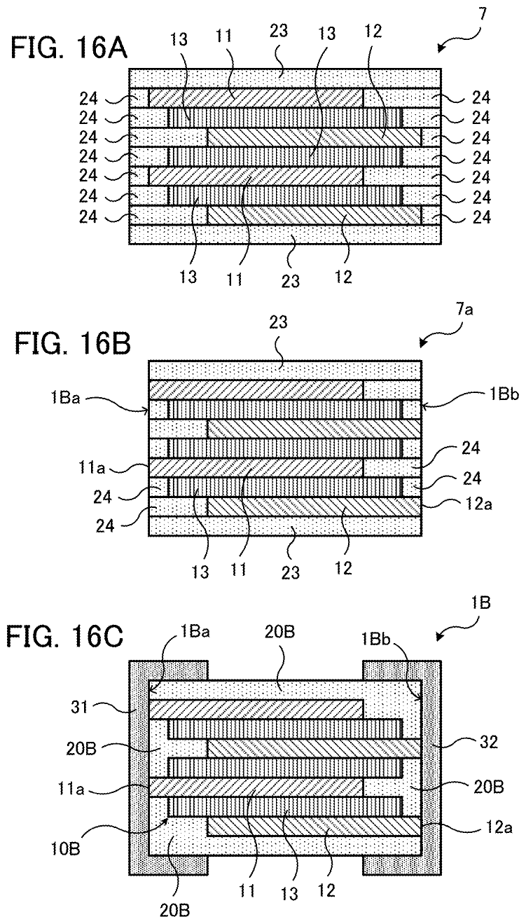

FIGS. 14A through 16C are views for describing another example of a solid-state battery manufacturing method. FIGS. 14A through 14E and FIGS. 15A through 15C are views for describing an example of an electrode layer part formation process. FIG. 14A is a fragmentary schematic perspective view of an example of a support preparation subprocess. FIG. 14B is a fragmentary schematic perspective view of an example of an electrode layer formation subprocess. FIG. 14C is a fragmentary schematic perspective view of an example of a first coating material layer formation subprocess. FIG. 14D is a fragmentary schematic perspective view of an example of an electrolyte layer formation subprocess. FIG. 14E is a fragmentary schematic perspective view of an example of a second coating material layer formation subprocess. Furthermore, FIG. 15A corresponds to FIG. 14E and is a fragmentary schematic perspective view of an example of an electrode layer part. FIG. 15B is a schematic sectional view taken along the chain line P3c of FIG. 15A. FIG. 15C is a schematic sectional view taken along the dotted line P4c of FIG. 15A. In addition, FIGS. 16A through 16C are views for describing an example of a process for forming a structural body and external electrodes. FIG. 16A is a fragmentary schematic sectional view of an example of a part group laminating subprocess. FIG. 16B is a fragmentary schematic sectional view of an example of a structural body cutting subprocess. FIG. 16C is a fragmentary schematic sectional view of an example of a subprocess for forming the external electrodes on the structural body after heat treatment.

As illustrated in FIG. 14B, part of a support 50, such as a PET film, illustrated in FIG. 14A is coated with the positive electrode paste or the negative electrode paste (also referred to as an “electrode paste”) by the use of the screen printing method, the positive electrode paste or the negative electrode paste is dried, and a positive electrode layer 11 or a negative electrode layer 12 (also referred to as an “electrode layer”) is formed. As illustrated in FIG. 14C, after the electrode layer (positive electrode layer 11 or the negative electrode layer 12) is formed, the periphery of the electrode layer formed on the part of the support 50 is coated with the coating material paste by the use of the screen printing method. The coating material paste is dried and a coating material layer 24 (buried layer) is formed.

Next, as illustrated in FIG. 14D, the electrode layer (positive electrode layer 11 or the negative electrode layer 12) and part of the coating material layer 24 formed therearound are coated with the electrolyte paste by the use of the screen printing method. The electrolyte paste is dried and an electrolyte layer 13 is formed. The electrolyte layer 13 is formed so that the coating material layer 24 not covered with the electrolyte layer 13 will remain on the entire periphery of the electrolyte layer 13. As illustrated in FIG. 14E, after the electrolyte layer 13 is formed, the entire periphery of the electrolyte layer 13 is coated with the coating material paste by the use of the screen printing method. The coating material paste is dried and a coating material layer 24 (buried layer) is formed.

For example, by performing the subprocesses illustrated in FIGS. 14A through 14E, a part having a sectional structure illustrated in FIG. 15B in the position of the chain line P3c of FIG. 15A and having a sectional structure illustrated in FIG. 15C in the position of the dotted line P4c of FIG. 15A is formed. The part illustrated in FIGS. 15A through 15C (and FIG. 14E) is used as a positive electrode layer part or a negative electrode layer part (also referred to as an “electrode layer part”) according to the type of electrode layer. Furthermore, the remainder after peeling the support 50 from the part illustrated in FIGS. 15A through 15C may be used as an electrode layer part. In addition, a part before the formation of the electrolyte layer 13 illustrated in FIG. 14C or the remainder after peeling the support 50 from this part may be used as an electrode layer part.

If a positive electrode layer part is formed as an electrode layer part, then the positive electrode layer 11 and the electrolyte layer 13 are formed so that part (part on the side of a positive electrode lead surface 1Ba described later) of the positive electrode layer 11 will protrude outside the electrolyte layer 13. Furthermore, if a negative electrode layer part is formed as an electrode layer part, then the negative electrode layer 12 and the electrolyte layer 13 are formed so that part (part on the side of a negative electrode lead surface 1Bb described later) of the negative electrode layer 12 will protrude outside the electrolyte layer 13.

In the example illustrated in FIGS. 14A through 14E and FIGS. 15A through 15C, the electrode layer (positive electrode layer 11 or the negative electrode layer 12) and the peripheral coating material layer 24 are formed on the support 50. After that, the electrolyte layer 13 and the peripheral coating material layer 24 are formed. However, this order may be reversed. That is to say, in accordance with the above example, the electrolyte layer 13 and the peripheral coating material layer 24 are formed on the support 50. After that, the electrode layer (positive electrode layer 11 or the negative electrode layer 12) and the peripheral coating material layer 24 may be formed.

The electrode layer part formed in this way is used. As illustrated in FIG. 16A, in accordance with the method illustrated in the above first example (FIGS. 5A through 9B), the positive electrode layer part, the negative electrode layer part, and a coating material sheet 23 in a determined form are laminated and are thermally pressure-bonded. By doing so, a structural body 7 is formed.

Furthermore, the method illustrated in the above second example (FIGS. 10A through 10D and FIGS. 11A through 11D) may be used. In accordance with the example illustrated in FIGS. 14A through 14E and FIGS. 15A through 15C, the positive electrode layer 11 or the negative electrode layer 12 is formed, the coating material layer 24 is formed therearound, the electrolyte layer 13 is formed on the positive electrode layer 11 or the negative electrode layer 12 and the coating material layer 24, and the coating material layer 24 is formed around the electrolyte layer 13. By doing so, the structural body 7 illustrated in FIG. 16A is obtained.

The structural body 7 illustrated in FIG. 16A is cut in positions in which an end surface of each positive electrode layer 11 and an end surface of each negative electrode layer 12 are exposed, and a structural body 7a illustrated in FIG. 16B is formed. With the structural body 7a, only the positive electrode layer 11 (portion 11a of the positive electrode layer 11), of the electrolyte layer 13, the positive electrode layer 11, and the negative electrode layer 12, is exposed on the positive electrode lead surface 1Ba and the negative electrode layer 12 or the electrolyte layer 13 is not exposed on the positive electrode lead surface 1Ba. Furthermore, with the structural body 7a, only the negative electrode layer 12 (portion 12a of the negative electrode layer 12), of the electrolyte layer 13, the positive electrode layer 11, and the negative electrode layer 12, is exposed on the negative electrode lead surface 1Bb and the positive electrode layer 11 or the electrolyte layer 13 is not exposed on the negative electrode lead surface 1Bb.

In addition, the structural body 7a after cutting illustrated in FIG. 16B is heat-treated for removing grease and burning. By doing so, an organic component, such as a binder, is burnt down and the solid electrolytes and the coating material are sintered. As a result, a solid-state battery body 10B illustrated in FIG. 16C and having the positive electrode layer 11, the negative electrode layer 12, and the electrolyte layer 13 intervening therebetween and a coating film 20B illustrated in FIG. 16C which covers the solid-state battery body 10B and which has hardness higher than that of the solid electrolytes used in the solid-state battery body 10B are formed. After that, an external electrode 31 and an external electrode 32 are formed on the positive electrode lead surface 1Ba and the negative electrode lead surface 1Bb respectively and a solid-state battery 1B illustrated in FIG. 16C is obtained.

With the solid-state battery 1B, only the positive electrode layer 11 (portion 11a of the positive electrode layer 11) of the solid-state battery body 10B is exposed on the positive electrode lead surface 1Ba and the positive electrode layer 11 is supported on part of the coating film 20B having hardness higher than that of the electrolyte layer 13. Furthermore, only the negative electrode layer 12 (portion 12a of the negative electrode layer 12) of the solid-state battery body 10B is exposed on the negative electrode lead surface 1Bb and the negative electrode layer 12 is supported on part of the coating film 20B having hardness higher than that of the electrolyte layer 13. With the solid-state battery 1B this further enhances the support and strength of the positive electrode layer 11 on the positive electrode lead surface 1Ba and the negative electrode layer 12 on the negative electrode lead surface 1Bb.

[Evaluation of Coating Film]

Results obtained by evaluating the hardness of a coating film used in a solid-state battery will now be described. The results are indicated in Table 1.

TABLE 1

| COATING FILM MATERIAL | VICKERS HARDNESS [GPA] |
|---|---|
| ELECTROLYTE | 4.58 |
| GLASS 1 | 5.80 |
| GLASS 2 | 5.72 |
| GLASS 1 + 10 wt. % Al2O3 | 6.65 |
| GLASS 2 + 10 wt. % Al2O3 | 6.25 |

In order to evaluate the hardness of a coating film, samples obtained by performing coating, drying, and heat treatment of the coating material paste used for forming the coating films 20A and 20B of the above solid-state batteries 1A and 1B, respectively, under the same conditions that are imposed when the solid-state batteries 1A and 1B are manufactured are prepared. In this case, two kinds of coating material pastes containing different glass components and obtained by performing coating, drying, and heat treatment under determined conditions are prepared as samples (“Glass 1” and “Glass 2” in Table 1). Furthermore, two kinds of coating material pastes which contain different glass components and to which 10 weight percent Al₂O₃ particles are added are prepared as samples (“Glass 1+10 wt. % Al₂O₃” and “Glass 2+10 wt. % Al₂O₃” in Table 1). In addition, the electrolyte paste used for forming the electrolyte layer 13 of the above solid-state batteries 1A and 1B and obtained by performing coating, drying, and heat treatment under the same conditions that are imposed when the solid-state batteries 1A and 1B are manufactured is prepared as a sample for comparison (“Electrolyte” in Table 1). After mirror finishing is performed on these five samples prepared, measurement is performed five or more times at a load of 200 g, 500 g, and 1000 g by the use of a Vickers hardness meter. A mean value is calculated as Vickers hardness (GPa).

It is ascertained from Table 1 that the Vickers hardness of the samples (“Glass 1” and “Glass 2”) formed from the two kinds of coating material pastes containing different glass components is higher than that of the sample (“Electrolyte”) formed from the electrolyte paste. Furthermore, it is ascertained that the Vickers hardness of the samples (“Glass 1+10 wt. % Al₂O₃” and “Glass 2+10 wt. % Al₂O₃”) formed from the two kinds of coating material pastes which contain different glass components and to which 10 weight percent Al₂O₃ particles are added is higher than that of the samples (“Glass 1” and “Glass 2”) to which 10 weight percent Al₂O₃ particles are not added.

From these evaluation results, a coating material paste containing a glass component or a coating material paste which contains a glass component and to which Al₂O₃ particles are added is used for forming the coating films 20A and 20B of the solid-state batteries 1A and 1B respectively. This makes it possible to cover the solid-state battery bodies 10A and 10B with the coating films 20A and 20B having hardness higher than that of the solid electrolytes used in the solid-state battery bodies 10A and 10B respectively.

[Modification]

In the above description, the example in which the solid-state battery body 10 including the one positive electrode layer 11 and the one negative electrode layer 12 is covered with the coating film 20 and the example in which the solid-state battery bodies 10A and 10B including the two positive electrode layers 11 and the two negative electrode layers 12 is covered with the coating films 20A and 20B respectively are given. However, the number of positive electrode layers 11 and negative electrode layers 12 included in a solid-state battery body covered with a coating film is not limited to the above examples. A solid-state battery body including three or more positive electrode layers 11 and three or more negative electrode layers 12 may be covered with the above coating film.

Furthermore, in the above description the coating material sheet 23 and the coating material layer 24, which is a buried layer, may be formed from coating material pastes which differ in composition. For example, as long as the coating material sheet 23 and the coating material layer 24 are sintered by the above heat treatment, the coating material sheet 23 incorporates with the coating material layer 24 by the above heat treatment, and the coating films 20A and 20B having hardness higher than that of the solid electrolytes used in the solid-state battery bodies 10A and 10B respectively are obtained, the coating material sheet 23 and the coating material layer 24 may be formed from coating material pastes which differ in composition. In addition, if the coating material layer 24 is formed by performing coating more than one time by the use of a coating material paste, then different coating material pastes may be used.

Furthermore, in the above description the example in which an oxide solid electrolyte is used in the electrolyte layer 13, the positive electrode layer 11, and the negative electrode layer 12 and in which LAGP is used as the oxide solid electrolyte is given. However, amorphous LAGP, crystalline LAGP, or both of crystalline LAGP and amorphous LAGP may be used as LAGP.

The composition of LAGP in the electrolyte layer 13 is not limited to Li_{1.5}Al_{0.5}Ge_{1.5}(PO₄)₃. NASICON type LAGP having another composition, such as Li_{1.4}Al_{0.4}Ge_{1.6}(PO₄)₃, may be used. An oxide solid electrolyte other than LAGP, such as Li_{1.3}Al_{0.3}Ti_{1.7}(PO₄)₃ which is one of NASICON-type LATP (general formula Li_{1+z}Al_{z}Ti_{2-z}(PO₄)₃ where 0<z≤1), garnet-type lanthanum lithium zirconate (Li₇La₃Zr₂O₁₂ hereinafter referred to as “LLZ”), perovskite-type lanthanum lithium titanate (Li_{0.5}La_{0.5}TiO₃ hereinafter referred to as “LLT”), or partially nitrided γ-lithium phosphate (γ-Li₃PO₄ hereinafter referred to as “LiPON”), may be used in the electrolyte layer 13.

As long as a constant performance is realized in combination with an active material used, an oxide solid electrolyte other than LAGP, such as LATP, LLZ, LLT, or LiPON, may be used in the positive electrode layer 11 and the negative electrode layer 12.

For example, a NASICON-type oxide solid electrolyte expressed by the general formula Li_{1+y}Al_{y}M_{2-y}(PO₄)₃ is suitable for the electrolyte layer 13, the positive electrode layer 11, and the negative electrode layer 12. In the above general formula, the composition ratio y is in the range of 0<y≤1 and M is one or both of germanium (Ge) and titanium (Ti).

Oxide solid electrolytes which are of the same kind may be used in the electrolyte layer 13, the positive electrode layer 11, and the negative electrode layer 12. Alternatively, oxide solid electrolytes which are of different kinds may be used in the electrolyte layer 13, the positive electrode layer 11, and the negative electrode layer 12. One kind of oxide solid electrolyte may be used in each of the electrolyte layer 13, the positive electrode layer 11, and the negative electrode layer 12. Alternatively, two or more kinds of oxide solid electrolytes may be used in each of the electrolyte layer 13, the positive electrode layer 11, and the negative electrode layer 12.

In addition, in the above description the example in which LCPO is used as a positive electrode active material contained in the positive electrode layer 11 is given. However, cobalt lithium phosphate (LiCoPO₄), vanadium lithium phosphate (Li₃V₂(PO₄)₃ hereinafter referred to as “LVP”), or the like may be used as a positive electrode active material. One kind of material may be used as a positive electrode active material contained in the positive electrode layer 11. Alternatively, two or more kinds of materials may be used as a positive electrode active material contained in the positive electrode layer 11.

Furthermore, in the above description the example in which TiO₂ is used as a negative electrode active material contained in the negative electrode layer 12 is given. However, metal silicide or the like may be used as a negative electrode active material. For example, LATP, LVP, niobium oxide (Nb₂O₅), nickel (Ni), or the like may be used as a negative electrode active material.

According to an aspect, a solid-state battery having excellent strength is realized.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that various changes, substitutions, and alterations could be made hereto without departing from the spirit and scope of the disclosure.

What is claimed is:

1. A solid-state battery comprising:
a laminated body including an electrolyte layer containing a solid electrolyte, a positive electrode layer provided on a part of a first principal plane of the electrolyte layer, and a negative electrode layer provided on a part of a second principal plane of the electrolyte layer opposite to the first principal plane; and
an insulating coating film which covers the laminated body so as to expose a first portion of the positive electrode layer and a second portion of the negative electrode layer and which has a hardness higher than a hardness of the solid electrolyte.

2. The solid-state battery according to claim 1, wherein the coating film contains a glass or a ceramic.

3. The solid-state battery according to claim 1, wherein:
the coating film is provided so as to be in contact with another part of the first principal plane of the electrolyte layer and a surface of the positive electrode layer except the first portion exposed from the laminated body, the positive electrode layer being formed on the part of the first principal plane; and
the coating film is provided so as to be in contact with another part of the second principal plane of the electrolyte layer and a surface of the negative electrode layer except the second portion exposed from the laminated body, the negative electrode layer being formed on the part of the second principal plane.

4. The solid-state battery according to claim 1, further comprising:
a first external electrode which is in contact with the first portion of the positive electrode layer and the coating film; and
a second external electrode which is in contact with the second portion of the negative electrode layer and the coating film.

5. The solid-state battery according to claim 1, wherein the coating film contains a first material phase having a first hardness and a second material phase having a second hardness higher than the first hardness.

6. A solid-state battery manufacturing method comprising:
forming a structural body including:
a laminated body including an electrolyte layer containing a solid electrolyte, a positive electrode layer formed on a part of a first principal plane of the electrolyte layer, and a negative electrode layer formed on a part of a second principal plane of the electrolyte layer opposite to the first principal plane; and
a coating material which covers the laminated body so as to expose a first portion of the positive electrode layer and a second portion of the negative electrode layer; and
burning the structural body at a first temperature and forming from the coating material an insulating coating film having a hardness higher than a hardness of the solid electrolyte.

7. The solid-state battery manufacturing method according to claim 6, wherein the burning of the structural body at the first temperature includes sintering the solid electrolyte and forming the coating film.
